(19) United States
(12) Patent Application Publication
(10) Pub. No.: US 2010/0302286 A1
(43) Pub. Date: Dec. 2, 2010

(54) LIGHT EMITTING DEVICE AND ELECTRONIC APPARATUS

(75) Inventor: Takayuki KITAZAWA, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/782,424

(22) Filed: May 18, 2010

(30) Foreign Application Priority Data
Jun. 2, 2009 (JP) 2009-132844

(51) Int. Cl. G09G 5/10

(52) U.S. Cl. 345/690

(57) ABSTRACT

A light emitting device includes: pixel circuits, each of which includes a light emitting element and a drive transistor connected in series with each other and a holding capacitor disposed between a path connecting the light emitting element and the drive transistor and a gate of the drive transistor; and a drive circuit which supplies a drive signal to the gate of the drive transistor and changes a potential of the drive signal with the passage of time such that a time rate of change of the potential of the drive signal at the time point of stopping the supply of the drive signal becomes a time rate of change corresponding to a designated gradation of the pixel circuit.

### BACKGROUND

1. Technical Field

The present invention relates to a technique for driving light emitting elements such as organic EL (Electroluminescence) elements.

2. Related Art

In a light emitting device in which a drive transistor controls a drive current supplied to light emitting elements, errors in the electrical characteristics of the drive transistor (such as a difference from a target value and a variation in respective elements) may cause a problem. JP-A-2007-310311 discloses a technique for compensating errors of a threshold voltage and mobility of the drive transistor (furthermore, an error in a current amount of a drive current) by setting a gate-to-source voltage of the drive transistor to a threshold voltage of the drive transistor and then changing it to a voltage corresponding to a gradation.

However, errors in the drive current are effectively compensated by the technique of JP-A-2007-310311 only when a specific gradation is designated. In some cases, errors in the drive current cannot be resolved depending upon the gradations. The present invention was made in order to suppress the errors in the drive current with respect to the plurality of gradations.

### SUMMARY

An advantage of some aspects of the invention is to provide a light emitting device including: pixel circuits, each of which includes a light emitting element and a drive transistor connected in series with each other and a holding capacitor disposed between a path connecting the light emitting element and the drive transistor and a gate of the drive transistor; and a drive circuit which supplies a drive signal to the gate of the drive transistor and changes a potential of the drive signal with the passage of time such that a time rate of change of the potential of the drive signal at the time point of stopping the supply of the drive signal becomes a time rate of change corresponding to a designated gradation of the pixel circuit. Here, the drive circuit includes: a lamp signal generating unit which generates a lamp signal; and an amplitude control unit which is supplied with the lamp signal, adjusts the amplitude of the lamp signal in accordance with a gradation to be displayed, and outputs the adjusted signal. Furthermore, the drive circuit generates the drive signal based on the output signal from the amplitude control unit.

According to the invention, when the drive signal is supplied to the gate of the drive transistor, a current corresponding to the time rate of change of the potential of the drive signal (a current independent from the threshold voltage and the mobility of the drive transistor) flows through the drive transistor. The voltage between both ends of the holding capacitor is set to a voltage for flowing through the drive transistor a current corresponding to the time rate of change of the potential of the drive signal at the time of stopping the supply of the drive signal to the gate of the drive transistor. More specifically, the voltage between both ends of the holding capacitor is set so as to flow through the drive transistor a current corresponding to the product between the time rate of change of the potential of the drive signal at the time of stopping the supply of the drive signal to the gate of the drive transistor and a capacitance value of the capacitor in the path between the light emitting element and the drive transistor. The time rate of change at the time of stopping the supply of the drive signal is set to be variable in accordance with the designated gradation of the pixel circuit. Accordingly, the drive current supplied to the light emitting element in accordance with the voltage between both ends of the holding capacitor is set to be an amount corresponding to the designated gradation (a current amount independent from the threshold voltage and the mobility of the drive transistor). In this regard, the time rate for change of the potential means a changing rate of the potential with the passage of time, and is equivalent to the potential gradient with respect to a time axis and the time differential value of the potential.

In addition, with regard to the drive signal, an amplitude of a lamp signal is adjusted in accordance with the gradation to be displayed. The lamp signal has a signal waveform with a constant time rate of change of the potential. Therefore, it is possible to adjust the time rate of change of the potential of the drive signal by adjusting the gain of the lamp signal in accordance with a gradation to be displayed.

The above-mentioned drive circuit is preferably provided with an offset unit for adding an offset potential to an output signal from the amplitude control unit and generating the drive signal (this corresponds to a second embodiment of the invention). With this configuration, it is possible to apply the offset potential to the drive signal. In this case, it is possible to shorten the time required for the drive current, which is supplied to the light emitting element in accordance with the voltage between both ends of the holding capacitor, to reach an equilibrium state with a current amount corresponding to the designated gradation (a current amount independent from the threshold voltage and the mobility of the drive transistor). This results in an advantage in an increase in the number of the scanning lines, and therefore it is possible to implement display images with high definition. Furthermore, the drive transistor reaches the equilibrium state without continuously varying the potential of the drive signal until the potential excessively rises. Accordingly, there is another advantage in that there is a reduction in the amplitude of the drive signal (this results in a mitigation of the pressure resistance requirement for the drive circuit).

As a specific configuration of the above-mentioned light emitting device, it is preferable that the lamp signal generating unit includes a capacitance element connected to a node, a constant current source with an output terminal connected to the node, a discharging unit which is connected to the node and discharges the electric charges charged in the capacitance element at a predetermined timing, and a buffer which has an input terminal connected to the node and outputs the lamp signal. With this configuration, it is possible to charge the capacitance element with the constant current and discharge the charged electric charge at a predetermined timing. Accordingly, it is possible to generate a lamp signal.

In addition, as a specific configuration of the above-mentioned light emitting device, the drive circuit is preferably supplied with designation data for designating a time rate of change of the potential of the drive signal. Here, the designation data preferably includes: a magnification bit for designating whether to increase or decrease the time rate of change of the potential of the drive signal compared with a time rate of change of the potential of the lamp signal; and a plurality of designation bits which designates a ratio between the time rates of change of the potentials of the drive signal and the lamp signal. Furthermore, the amplitude control unit preferably controls the gain in accordance with the plurality of designation bits such that the gain becomes one or more when the magnification bit designates the increase in the time rate of change of the potential of the lamp signal and the gain becomes less than one when the magnification bit designates the decrease in the time rate of change of the potential of the lamp signal.

As described above, it is possible to improve an SN ratio and reduce the power consumption by designating the gain so as to amplify or attenuate the lamp signal. For example, according to a method in which the lamp signal is generated so as to have an amplitude corresponding to a minimum gain and amplified with a gain corresponding to the gradation to be displayed, the lamp signal has a small amplitude, and the SN ratio of the lamp signal is unfavorably decreased. On the other hand, according to the method in which the lamp signal is generated so as to have an amplitude corresponding to a maximum gain and attenuated with an attenuation ratio corresponding to the gradation to be displayed, the lamp signal has a large amplitude, and the power consumption is increased.

Although there is a trade-off relationship between the SN ratio and the power consumption, it is possible to balance the improvement of the SN ratio with the decrease in the power consumption by setting the time rate of change of the lamp signal to the intermediate gradation of the gradation to be displayed (that is, by designating the increase and the decrease using the magnification bit).

More specifically, the amplitude control unit preferably includes an amplification circuit having input resistances; feedback resistances; and an operational amplifier. Here, the amplitude control unit selects magnitudes of the input resistances in accordance with the magnification bit, and selects magnitude of the feedback resistances in accordance with the plurality of designation bits.

In addition, the drive circuit preferably includes a storage unit which associates gradation data for instructing a gradation to be displayed with the designation data and stores both the data. Here, when the gradation data is supplied, the drive circuit preferably converts the gradation data into the designation data with reference to the contents stored in the storage unit. In this case, it is possible to obtain the designation data with reference to the storage unit. Accordingly, it is possible to generate designation data in real time without need for an operation process.

It is preferable that the light emitting device described above includes: a plurality of scanning lines; a plurality of data lines; and the plurality of pixel circuits, each of which is disposed at each of the intersections between the plurality of scanning lines and the plurality of data lines. Here, the drive circuit preferably includes: the single lamp signal generating unit; and the plurality of amplitude control units to which the lamp signal is supplied. Furthermore, the drive circuit preferably supplies the drive signal output from the plurality of amplitude control unit to the plurality of data lines. According to the present invention, it is possible to allow the plurality of amplitude control units to function as the lamp signal generating unit in addition to their original functions. Therefore, it is possible to significantly simplify the configuration as compared with the case in which a lamp signal generating unit is provided for each of the plurality of amplitude control units. In addition, since the same lamp signal is supplied to each of the plurality of amplitude control units, it is possible to implement the waveform of the lamp signal with no variation.

Another advantage of some aspects of the invention is to provide an electronic apparatus including the above-mentioned light emitting device according to the invention. A typical example of the electronic apparatus is an apparatus using the light emitting device as a display device. A personal computer and a mobile phone can be exemplified as the electronic apparatuses according to the present invention. However, the purpose of the light emitting device according to the invention is not limited to the display of images. For example, the light emitting device according to the invention can be used as an exposure device (an optical head) which forms latent images on an image carrier such as a photoconductor drum by irradiating a light beam.

### BRIEF DESCRIPTION OF THE DRAWINGS

The invention will be described with reference to the accompanying drawings, wherein like numbers reference like elements.

FIG. 1 is a circuit diagram illustrating a drive principle of a pixel circuit.

FIG. 2 is a graph illustrating the drive principle of the pixel circuit.

FIG. 3 is a block diagram of a light emitting device according to an embodiment of the invention.

FIG. 4 is a circuit diagram of a pixel circuit.

FIG. 5 is a timing chart illustrating operations of the light emitting device.

FIG. 6 is a waveform diagram of drive signals.

FIG. 7 is a circuit diagram of a signal line drive circuit.

FIG. 8 is a circuit diagram of a lamp signal generating circuit.

FIGS. 9A and 9B are circuit diagrams of equivalent circuits for a first constant current source and a second constant current source.

FIG. 10 is an explanatory diagram illustrating ON-OFF relationships between a lamp signal and switches SW1 to SW6.

FIG. 11 is a block diagram illustrating a configuration of a driver unit.

FIG. 12 is a circuit diagram illustrating a configuration of an amplitude control circuit.

FIG. 13 is a circuit diagram illustrating a configuration of an offset circuit.

FIGS. 14A and 14B are graphs illustrating time required for a drive transistor to reach an equilibrium state when a time rate of change of a potential of the drive signal is high.

FIGS. 15A and 15B are graphs illustrating time required for a drive transistor to reach an equilibrium state when a time rate of change of a potential of the drive signal is low.

FIG. 16 is a timing chart illustrating a waveform of a drive signal and a control signal according to a second embodiment.

FIG. 17 is a timing chart illustrating a relationship between the drive signal and a current (represented by a solid line).

FIG. 18 is a perspective view of an electronic apparatus (a personal computer).

FIG. 19 is a perspective view of an electronic apparatus (a mobile phone).

FIG. 20 is a perspective view of an electronic apparatus (a personal digital assistant).

### DESCRIPTION OF EXEMPLARY EMBODIMENTS

### A: Drive Principle

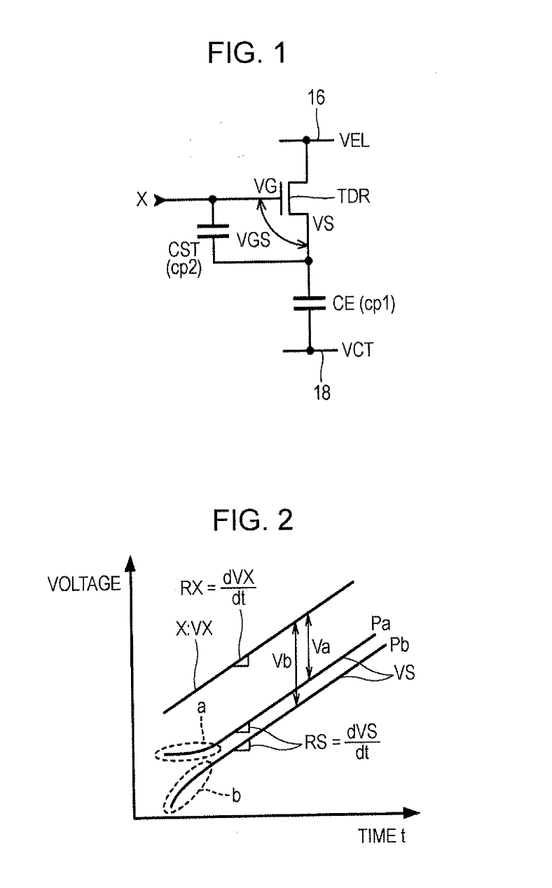

Before explaining specific embodiments of the invention, a description will be made of a principle used for driving a pixel circuit in each embodiment. As shown in FIG. 1, a circuit in which an N-channel drive transistor TDR and a capacitor CE (capacitance value cp1) are arranged in series on a path connecting a power supply line 16 and a power supply line 18 is assumed.

The power supply line 16 is supplied with a potential VEL while the power supply line 18 is supplied with a potential VCT (VCT<VEL). A drain of the drive transistor TDR is connected to the power supply line 16, and the capacitor CE is disposed between a source of the drive transistor TDR and the power supply line 18. A holding capacitor CST (capacitance value cp2) is disposed between the gate and the source of the drive transistor TDR. Accordingly, a voltage VGS (VGS=VG−VS) as a difference between the gate potential VG and the source potential VS of the drive transistor TDR is applied between both ends of the holding capacitor CST.

The gate of the drive transistor TDR is supplied with a drive signal X. A potential VX of the drive signal X varies with the passage of time as shown in FIG. 2. FIG. 2 shows an example of a case in which the potential VX rises in a linear fashion with a predetermined time rate of change RX (RX=dVX/dt). In addition, FIG. 2 also shows time variations of the source potentials VS in both the case in which the electrical characteristic (for example, the mobility or the threshold voltage) of the drive transistor TDR is a characteristic Pa and the case in which the electrical characteristic thereof is a characteristic Pb, respectively.

When the gate potential VG (the potential VX) of the drive transistor TDR is raised by supplying the drive signal X, and the gate-to-source voltage VGS of the drive transistor TDR exceeds the threshold voltage VTH of the drive transistor TDR, a current IDS flows between the drain and the source of the drive transistor TDR. The current IDS is represented by the following equation (1). Here, μ in the equation (1) denotes the mobility of the drive transistor TDR. In addition, W/L denotes a relative ratio of a channel width W to a channel length L of the drive transistor TDR, and Cox denotes a capacitance value for each unit area of a gate insulating film of the drive transistor TDR.

IDS=½·μ·W/L·Cox·(VGS−VTH)² (1)

Meanwhile, when the current IDS flows through the drive transistor TDR, the capacitor CE and the holding capacitor CST are electrically charged. Therefore, the source potential VS of the drive transistor TDR varies with the passage of time with the time rate of change RS (RS=dVS/dt) as shown in FIG. 2. A relationship represented by the following equation (2) is satisfied between the current IDS and the source potential VS of the drive transistor TDR.

IDS=dQ/dt=cp2·(dVS/dt−dVX/dt)+cp1·dVS/dt (2)

As shown in a portion a in FIG. 2, when the time rate of change (that is, the gradient of the potential VS with respect to time t) RS of the source potential VS of the drive transistor TDR is lower than the time rate of change RX of the potential VX of the drive signal X, the gate-to-source voltage VGS of the drive transistor TDR increases with the passage of time. As represented by the equation (1), when the voltage VGS increases, the current IDS also increases. In addition, as can be understood from the equation (2), when the current IDS increases, the time rate of change RS also increases. That is, when the time rate of change RS is lower than the time rate of change RX, the time rate of change RS increases.

On the other hand, as shown in a portion b of FIG. 2, when the time rate of change RX of the potential VX of the drive signal X is lower than the time rate of change RS of the source potential VS, the gate-to source voltage VGS decreases with the passage of time. Therefore, as can be understood from the equation (1), the current IDS decreases. When the current IDS decreases, the time rate of change RS also decreases. That is, when the time rate of change RS exceeds the time rate of change RX, the time rate of change RS decreases.

As described above, the time rate of change RS of the source potential VS of the drive transistor TDR approaches the time rate of change RX of the potential VX of the drive signal X with the passage of time, and finally reaches the time rate of change RX regardless of the characteristic of the drive transistor TDR (that is, in both cases of the characteristics Pa and Pb). The state in which the time rate of change RS is equal to the time rate of change RX (hereinafter, referred to as a “equilibrium state”) can be also expressed as a state in which the increase in the voltage VGS due to the rise of the potential VX of the drive signal X comes to equilibrium with the decrease in the voltage VGS due to charging by the current IDS.

Since the time rate of change RS is equal to the time rate of change RX (RS=dVS/dt=RX=dVX/dt) in the equilibrium state, the equation (2) can be changed to the following equation (3). That is, the current IDS flowing through the drive transistor TDR is proportional to the time rate of change RX of the potential VX of the drive signal X. More specifically, the current IDS depends only upon the capacitance value cp1 of the capacitor CE and the time rate of change RX of the potential VX, and does not depend upon the mobility μ or the threshold voltage VTH of the drive transistor TDR.

IDS=cp2·(dVS/dt−dVX/dt)+cp1·dVS/dt=cp2·(dVX/dt−dVX/dt)+cp1·dVX/dt=cp1·RX (3)

The gate-to-source voltage VGS of the drive transistor TDR is automatically set in accordance with the mobility μ and the threshold voltage VTH thereof by the voltage required for flowing the current IDS in the equation (3), which does not depend on the mobility μ and the threshold voltage VTH, through the drive transistor TDR (that is, the voltage VGS which satisfies the equation (1) with respect to the current IDS of the equation (3)). When the drive transistor TDR has the characteristic Pa of FIG. 2, for example, the voltage VGS is set to a voltage Va. When the drive transistor TDR has the characteristic Pb of FIG. 2, the voltage VGS is set to a voltage Vb. In the equilibrium state, a common current IDS depending only upon the capacitance value cp1 and the time rate of change RX flows through the drive transistor TDR in both the cases of characteristics Pa and Pb.

The current IDS continuously flows through the drive transistor TDR even after stopping the supply of the drive signal X (potential VX) by allowing the gate-to-source voltage VGS set as described above to be held by the holding capacitor CST. In the respective embodiments described later, the current IDS is used as a current IDR for driving the light emitting elements (hereinafter, referred to as a “drive current”). As already described with reference to the equation (3), the current IDS does not depend upon the characteristic (the mobility μ or the threshold voltage VTH) of the drive transistor TDR. Therefore, it is possible to compensate the error of the drive current IDR due to the characteristic of the drive transistor TDR (and furthermore the luminance error of the light emitting elements). Meanwhile, the drive current IDR (the current IDS) depends on the time rate of change RX of the potential VX of the drive signal X. Accordingly, it is possible to set the amount of the drive current IDR (and the luminance of the light emitting elements) to be variable by controlling the time rate of change RX of the drive signal X.

### B: Embodiments

### B-1: Configuration and Operation of Light Emitting Device

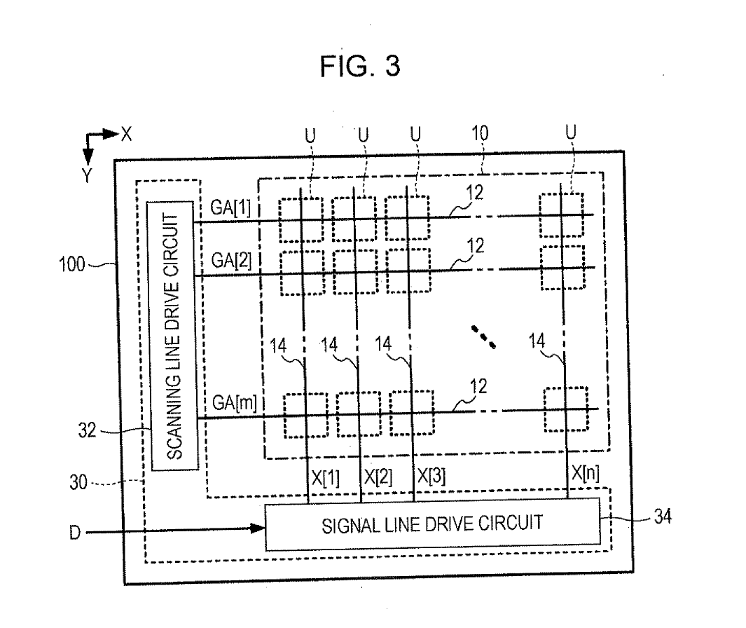

FIG. 3 is a block diagram of the light emitting device according to an embodiment of the invention. The light emitting device 100 is mounted as a display device for displaying images on an electronic apparatus. As shown in FIG. 3, the light emitting device 100 includes an element part 10 in which a plurality of pixel circuits U is arranged and a drive circuit 30 for driving each pixel circuit U. The drive circuit 30 includes a scanning line drive circuit 32 and a signal line drive circuit 34. The drive circuit 30 is divided into a plurality of integrated circuits and mounted. However, at least a part of the drive circuit 30 can be configured as a thin film transistor formed with the pixel circuits U on the substrate.

In the element part 10, m scanning lines 12 extending in X direction and n signal lines 14 extending in Y direction perpendicular to the X direction are formed (m and n are natural numbers). The plurality of pixel circuits U are disposed on intersections between each scanning line 12 and each signal line 14, and arranged in a matrix shape with m rows in a vertical direction and n columns in a horizontal direction. The scanning line drive circuit 32 outputs scanning signals GA[1] to GA[m] to each scanning line 12. The signal line drive circuit 34 outputs a drive signal X (X[1] to X[n]) corresponding to a gradation D designated by each pixel circuit U (hereinafter, referred to as a “designated gradation”) to each signal line 14. In this regard, the designated gradation D is provided as gradation data for designating a gradation.

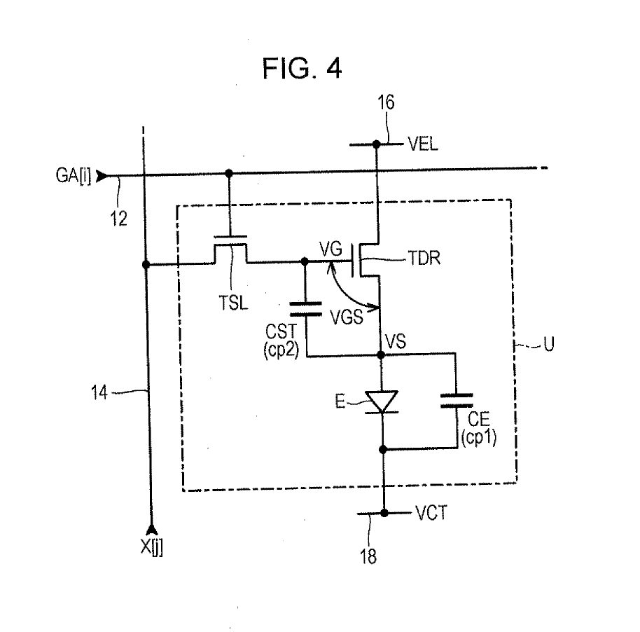

FIG. 4 is a circuit diagram of the pixel circuit U. FIG. 4 shows only one pixel circuit U disposed on the i-th row (i=1 to m) and j-th column (j=1 to n) as a representative. As shown in FIG. 4, the pixel circuit U is configured to have a light emitting element E, a drive transistor TDR, a holding capacitor CST, and a selection switch TSL.

The light emitting element E and the drive transistor TDR are arranged in series on the path connecting the power supply line 16 (the potential VEL) and the power supply line (the potential VCT). The light emitting element E is an organic EL element in which a light emitting layer of an organic EL (Electroluminescence) material is interposed between a positive electrode and a negative electrode facing each other. As shown in FIG. 4, the capacitor CE (capacitance value cp1) of FIG. 1 is associated with the light emitting element E.

The drive transistor TDR is an N-channel transistor (for example, a thin film transistor) with a drain connected to the power supply line 16 and a source connected with the positive electrode of the light emitting element E. The holding capacitor CST (capacitance value cp2) is disposed between the source of the drive transistor TDR (that is, a path between the light emitting element E and the drive transistor TDR) and the gate of the drive transistor TDR.

The selection switch TSL is disposed between the signal line 14 and the gate of the drive transistor TDR so as to control the electrical connection (a conductive state or a non-conductive state) therebetween. As shown in FIG. 4, an N-channel transistor (a thin film transistor), for example, is preferably employed as a selection switch TSL. The gate of the respective selection switches TSL of n pixel circuits U belonging to the i-th row is connected to a common scanning line 12 of i-th row.

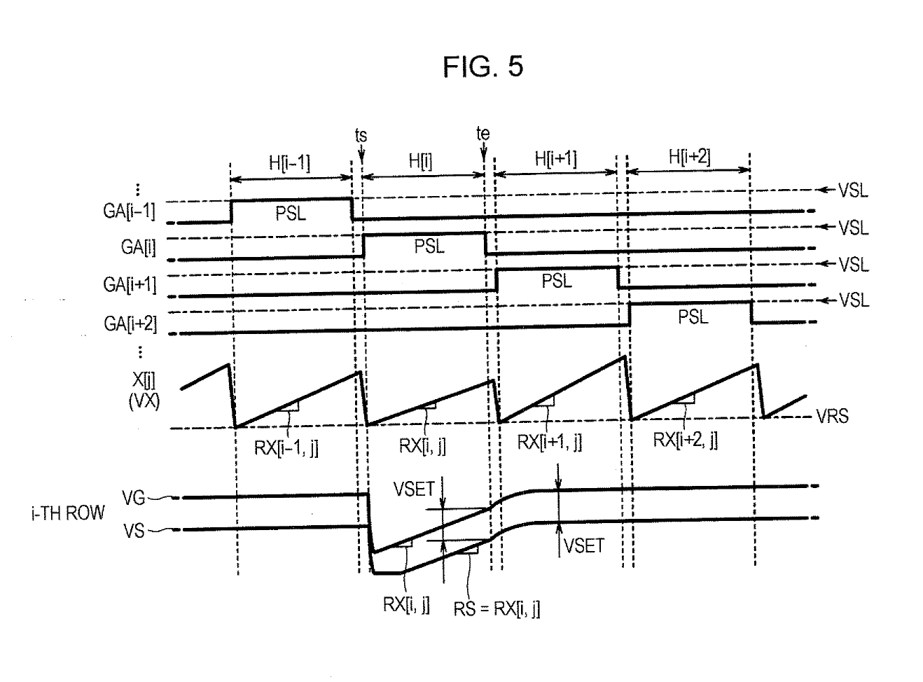

Next, with reference to FIG. 5, the description will be made of operations of the drive circuit 30 (a driving method of the pixel circuit U) while focusing on the pixel circuit U positioned on the i-th row and the j-th column. The scanning line drive circuit 32 sequentially sets the scanning signals GA[1] to GA[m] to a selection potential VSL (an active level) for each of m unit periods H (H[1] to H[m]) in a vertical scanning period, thereby sequentially selecting each scanning line 12 (a group of n pixel circuits U on each row). As shown in FIG. 5, the scanning signal GA[i] is a voltage signal with a selection pulse PSL of the selection potential VSL arranged in the i-th unit period H[i] in the vertical scanning period. The selection pulse PSL (the selection potential VSL) means a selection of the scanning line 12. When the scanning signal GA[i] shifts to the selection potential VSL (that is, when the selection pulse PSL is supplied), each of the selection switches TSL of n pixel circuits U belonging to the i-th row is turned on simultaneously.

The signal line drive circuit 34 generates drive signals X[1] to X[n] with the potential VX varying with the passage of time for each unit period H and outputs the drive signals to each signal line 14. The potential VX of the drive signal X[1] to X[n] is respectively set to a reference potential VRS at a start time point ts of the unit period H, and rises in a linear fashion with the time rate of change RX (RX=dVX/dt) from the start time point ts to a last time point to of the unit period H. That is, the drive signals X[1] to X[n] are voltage signals with lamp waveforms (saw tooth waveforms) with a unit period H as a cycle.

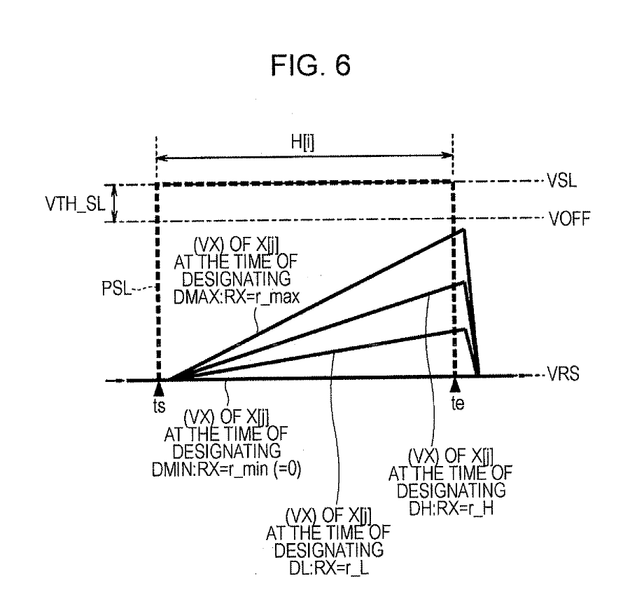

The time rate of change RX[i, j] of the potential VX the drive signal X[j] supplied to the signal line 14 of the j-th column in the unit period H[i] during which the scanning line 12 of the i-th row is selected is set to be variable in accordance with the designated gradation D of the pixel circuit U positioned on the i-th row and the j-th column. More specifically, as an example shown in FIG. 6, when the designated gradation D of the pixel circuit U is increased (when the drive current IDR to be supplied to the light emitting element E is larger), the time rate of change RX[i, j] of the potential VX of the drive signal X[j] in the unit period H[i] is set to a larger value. That is, when the designated gradation D of the pixel circuit U is increased, the gradient of the potential VX with respect to time axis is steeper.

For example, when the designated gradation D is a minimum gradation DMIN (a black display in which the light emitting element E is not supplied with the drive current IDR), the time rate of change RX[i, j] of the potential VX of the drive signal X[j] is set to a minimum value r_min (zero). That is, the potential VX of the drive signal X[j] does not vary in the unit period H[i]. On the other hand, when the designated gradation D is a maximum gradation DMAX (a white display), the time rate of change RX[i, j] of the potential VX of the drive signal X[j] is set to a maximum value r_max. Furthermore, a set value r_H of the time rate of change RX[i, j] in the case where an intermediate gradation DH is designated exceeds a set value r_L of the time rate of change RX[i, j] in the case where an intermediate gradation DL lower than the intermediate gradation DH is designated.

The maximum value r_max of the time rate of change RX[i, j] corresponding to the maximum gradation DMAX is set such that the difference between the potential VX of the drive signal X[j] and the selection potential VSL of the selection pulse PSL (the gate-to-source voltage of the selection switch TSL) exceeds a threshold voltage VTH_SL of the selection switch TSL at the last time point te of the unit period H[i]. That is, as shown in FIG. 6, the potential VX of the drive signal X[j] at the last time point te of the unit period H[i] is lower than the potential VOFF which is lower than the selection potential VSL by the threshold voltage VTH_SL regardless of the designated gradation D which may be any gradation from the minimum gradation DMIN to the maximum gradation DMAX. Accordingly, the selection switch TSL shifts to the OFF state at the last time point to of the unit period H[i] (the latter edge of the selection pulse PSL) regardless of the designated gradation D.

When the selection switch TSL of the respective pixel circuits U of the i-th row is turned on by supplying the selection pulse PSL of the scanning signal GA[i] from the scanning line drive circuit 32, the gate of the drive transistor TDR becomes conductive with the signal line 14. Thus, the gate of the drive transistor TDR of the pixel circuit U disposed on the i-th row and j-th column is supplied with the drive signal X[j] in the same manner as in the example of FIG. 1. In addition, the gate potential VG of the drive transistor TDR rises with the passage of time with the time rate of change RX[i, j] corresponding to the designated gradation D of the pixel circuit U as shown in FIG. 5. On the other hand, the source potential VS rises with the passage of time by flowing the current IDS corresponding to the variation in the potential VG between the drain and the source of the drive transistor TDR. When reaching the equilibrium state in which the time rate of change RS (RS=dVS/dt) of the potential VS is equal to the time rate of change RX[i, j] of the potential VX of the drive signal X[1], the current IDS depending only on the capacitance value cp1 of the capacitor CE and the time rate of change RX[i, j] flows through the drive transistor TDR up to the last time point te of the unit period H[i].

When the supply of the selection pulse PSL is terminated at the last time point te of the unit period H[i] (that is, when the scanning signal GA[i] falls from the selection potential VSL), the selection switch TSL is turned off, and thereby the supply of the drive signal X[j] to the gate of the drive transistor TDR is stopped. As shown in FIG. 5, the holding capacitor CST holds the voltage VSET corresponding to the current IDS which was flowing through the drive transistor TDR at the time of stopping the supply of the drive signal X[j]. That is, the voltage VSET is a gate-to-source voltage VGS required for flowing through the drive transistor TDR the current IDS of the equation (3) depending only on the capacitance value cp1 of the capacitor CE and the time rate of change RX[i, j] (that is, the current IDS independent from the mobility μ and the threshold voltage VTH of the drive transistor TDR).

The holding capacitor CST holds the voltage VSET, and thereby the current IDS flows between the drain and the source of the drive transistor TDR even after stopping the supply of the drive signal X[j]. Accordingly, the source potential VS of the drive transistor TDR rises with the passage of time. Meanwhile, when the selection switch TSL shifts to the OFF state, the gate of the drive transistor TDR enters an electrically floating state. Therefore, as shown in FIG. 5, the gate potential VG of the drive transistor TDR rises in conjunction with the source potential VS. That is, the voltage between both ends of the capacitor CE (the source potential VS of the drive transistor TDR) gradually rises while the gate-to-source voltage VGS of the drive transistor TDR is maintained to be the voltage VSET set in the unit period H[i]. Subsequently, when the voltage between both ends of the capacitor CE reaches the threshold voltage VTH_OLED of the light emitting element E, the current IDS corresponding to the voltage VSET flows through the light emitting element E as the drive current IDR. The light emitting element E emits light with the luminance corresponding to the amount of the drive current IDR (the designated gradation D).

The drive current IDR is maintained to have an amount substantially equal to that of the current IDS which was flowing through the drive transistor TDR at the time of stopping the supply of the drive signal X[j]. The current IDS depends on the time rate of change RX[i, j] set to be variable in accordance with the designated gradation D (the equation (3)). Therefore, the light emitting element E is supplied with the drive current IDR of an amount in accordance with the designated gradation D. As described above, the light emitting element E of the pixel circuit U disposed on the i-th row and the j-th column is supplied after the elapse of the unit period H[i] with the drive current IDR corresponding to the time rate of change RX[i, j] (the designated gradation D) of the potential VX of the drive signal X[j] in the unit period H[i].

For example, the time rate of change RX[i, j] in the case where the minimum gradation DMIN is designated is set to be the minimum value r_min (zero). Therefore, the light emitting element E is controlled to have the minimum gradation (a black display) by setting the amount of the drive current IDR to zero. The amount of the drive current IDR (the gradation of the light emitting element E) in the case where the time rate of change RX[i, j] of the drive signal X[j] is set to the set value r_H corresponding to the intermediate gradation D_H exceeds the amount of the drive current IDR in the case where the time rate of change RX[i, j] is set to the set value r_L (r_L<r_H) corresponding to the intermediate gradation D_L. In addition, since the time rate of change RX[i, j] in the case where the maximum gradation DMAX is designated is set to the maximum value r_max, the amount of the drive current IDR is set to the maximum value, and thereby the light emitting element E is controlled to have a maximum gradation (a white display). The drive current IDR is continuously supplied until the voltage VSET of both ends of the holding capacitor CST is updated in the next unit period H[i] during which the scanning line 12 of the i-th row is selected.

In the above embodiment, the voltage VSET of both ends of the holding capacitor CST is set such that the current IDS corresponding to the time rate of change RX[i, j] of the potential VX of the drive signal X[j] (the current independent from the mobility μ and the threshold voltage VTH of the drive transistor TDR) flows through the drive transistor TDR. Therefore, it is possible to suppress errors of the drive current IDR (and furthermore errors of the luminance of the light emitting elements E) due to the characteristic (such as the mobility μ and the threshold voltage VTH) of the drive transistor TDR regardless of the designated gradation D of the respective pixel circuits U. Accordingly, there is an advantage of suppressing the non-uniformity in gradations of the image to be displayed by the element part 10.

### B-2: Configuration of Signal Line Drive Circuit 34

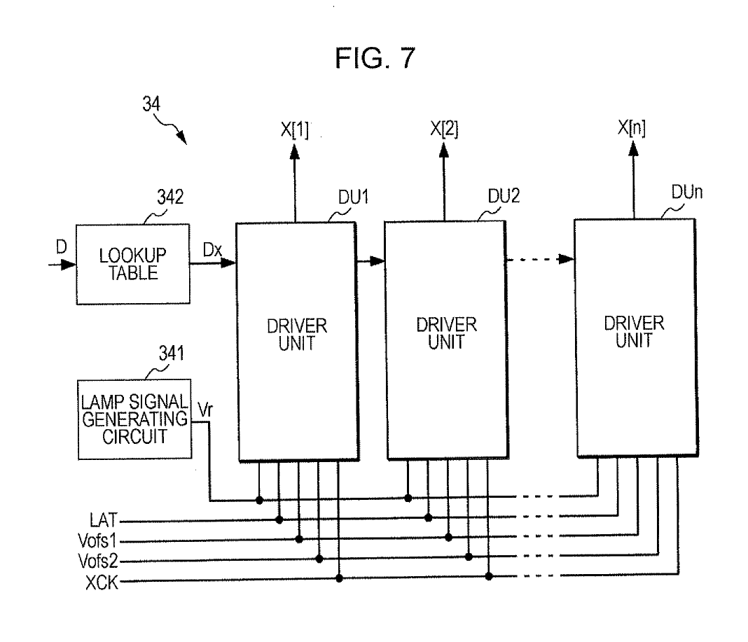

FIG. 7 is a block diagram of the signal line drive circuit 34. The signal line drive circuit 34 is configured to include a lamp signal generating circuit 341, a lookup table 342, and n driver units DU1, DU2, . . . , and DUn corresponding to the total number of the signal line 14 (the number of columns of the pixel circuits U). The signal line drive circuit 34 is supplied with an X clock signal XCK, a designated gradation D, a latch signal LAT, a first offset voltage Vofs1, and a second offset voltage Vofs2 from a control circuit which is not shown in the drawing.

The lamp signal generating circuit 341 generates a lamp signal Vr of which a potential varies with a constant time rate of change, and supplies the signal to the n driver units DU1, DU2, . . . , and DUn.

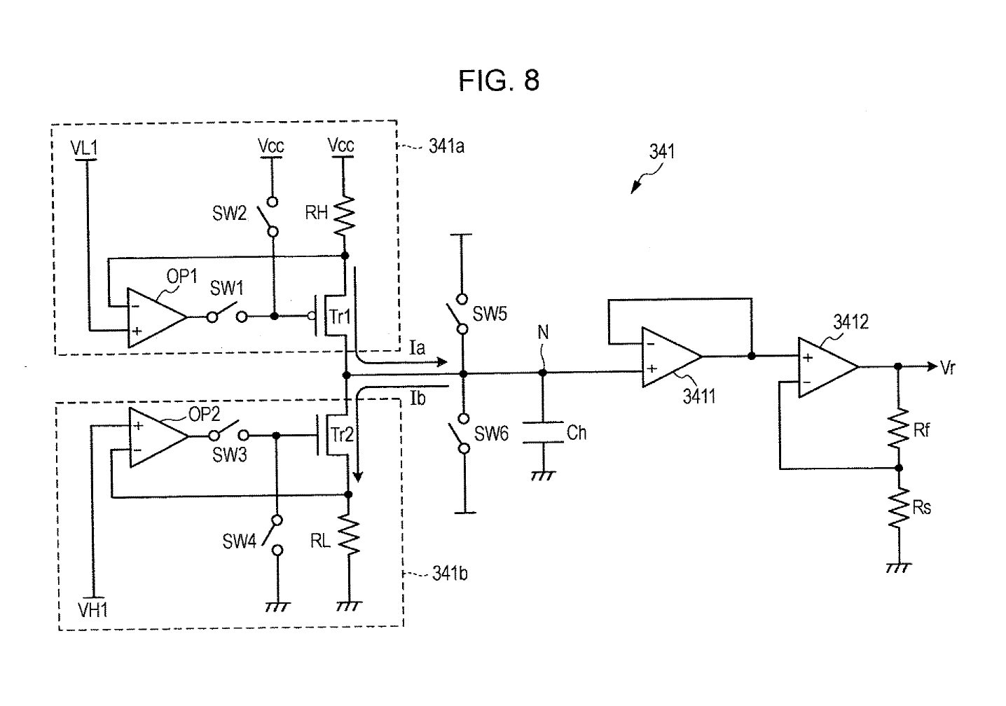

FIG. 8 is a detailed circuit diagram of the lamp signal generating circuit 341. The lamp signal generating circuit 341 includes a first constant current source 341a, a second constant current source 341b, a switch SW5, a switch SW6, a capacitance element Ch, a voltage follower 3411, and an amplifier 3412.

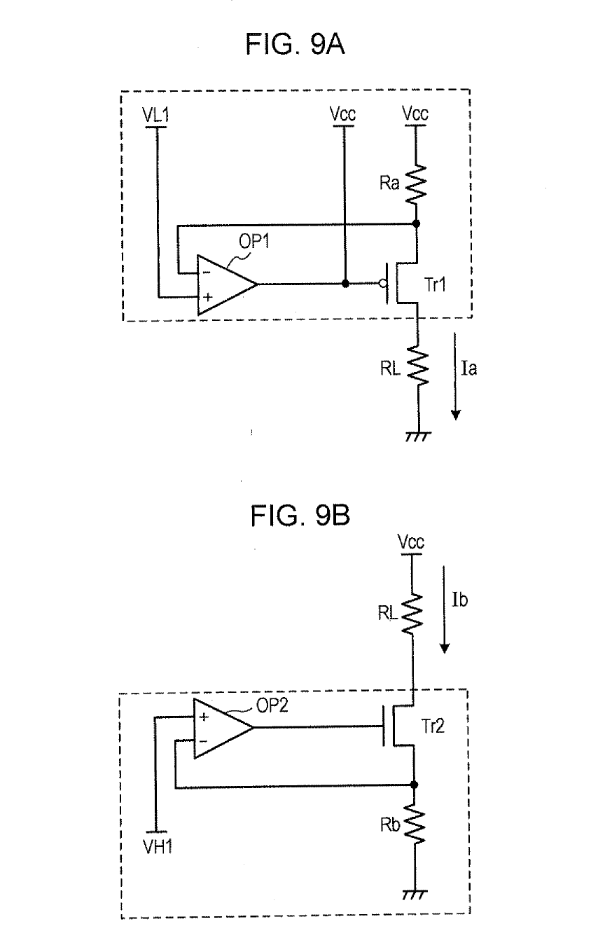

The first constant current source 341a flows a current Ia into a node N, and the second constant current source 341b draws a current Ib from the node N. Here, FIGS. 9A and 9B show equivalent circuits of the first constant current source 341a and the second constant current source 341b in the case where the switches SW1, SW2, SW3, and SW4 are in the ON state.

The current Ia of the first constant current source 341a will be considered. Here, if a gain of an operational amplifier OP1 is represented as A1, and an output of the operational amplifier OP1 is represented as Vout1, the following equations are satisfied.

A1·{VL1−(Vcc−Ia·Ra)}=Vout1

VL1−(Vcc−Ia·Ra)=Vout1/A1

Here, if A1>>Vout1 is satisfied, the right side of the equation becomes 0 as follows:

VL1−(Vcc−Ia·Ra)=0

If this equation is solved for Ia, the following equation can be obtained:

Ia=(Vcc−VL1)/Ra

From this equation, it can be understood that the current Ia has a constant magnitude.

Next, the current Ib of the second constant current source 341b will be considered. Here, if a gain of an operational amplifier OP2 is represented as A2, and an output of the operational amplifier OP2 is represented as Vout2, the following equations are satisfied.

A2·(VH1−Ib·Rb)=Vout2

(VH1−Ib·Rb)=Vout2/A2

Here, if A2>>Vout2 is satisfied, the right side of the equation becomes 0 as follows:

(VH1−Ib·Rb)=0

If this equation is solved for Ib, the following equation can be obtained:

Ib=VH1/Rb

From this equation, it can be understood that the current Ib has a constant magnitude.

In the lamp signal generating circuit 341 shown in FIG. 8, it is possible to generate a lamp waveform by charging the capacitance element Ch with the current Ia or the current Ib and discharging the electric charge charged in the capacitance element Ch through the switch SW5 or SW6 at a predetermined timing. The switch SW5 or SW6 functions as a unit for discharging the electric charge charged in the capacitance element Ch.

The lamp waveform of the node N obtained in this manner is supplied to the amplifier 3412 through the voltage follower 3411 which functions as a buffer, and amplified here to be output as a lamp signal Vr.

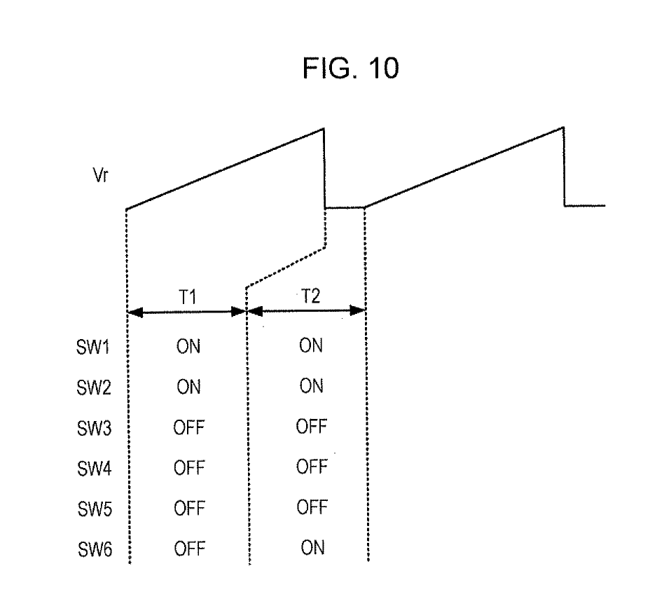

FIG. 10 shows ON-OFF relationships between the lamp signal Vr and the switches SW1 to SW6. As shown in FIG. 10, when the lamp waveform is rising with the passage of time, the switches SW1 and SW2 are always in the ON state, and the switches SW3, SW4, and SW5 are always in the OFF state. That is, the first constant current source 341a and the switch SW6 are being operated while the second constant current source 341b and the switch SW5 are stopping their operations. Accordingly, when the rising lamp signal Vr is generated as shown in FIG. 10, the second constant current source 341b and the switch SW5 may be omitted. In addition, when a falling lamp signal Vr is generated, the second constant current source 341b and the switch SW5 are operated, and the first constant current source 341a and the switch SW6 are stopped.

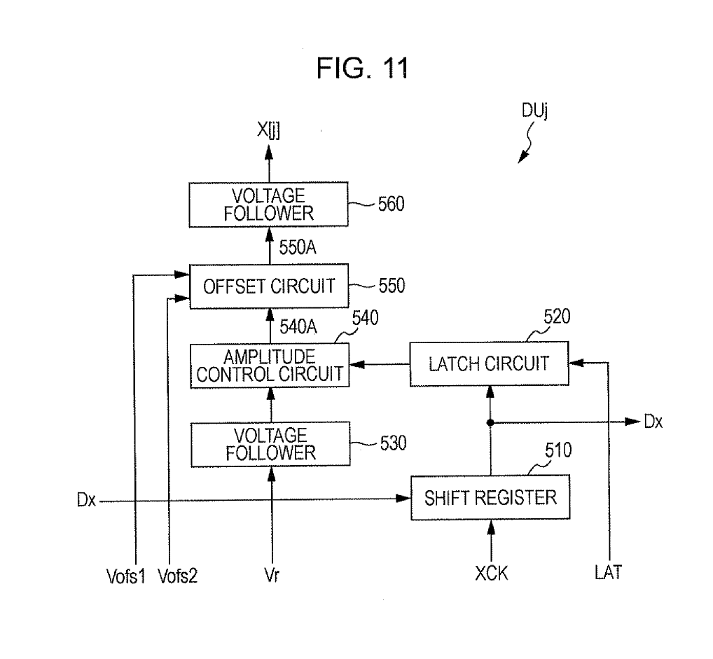

Next, the description will be made of the driver unit DUj (where j is a natural number satisfying the relation of 1≦j≦n). FIG. 11 is a block diagram of the driver unit DUj.

The designation data Dx transferred from the driver unit DUi−1 of a previous stage (or from the lookup table 342 in the case of j=1) is delayed by the shift register 510 by one cycle of the X clock signal XCK, and supplied to the latch circuit 520. The designation data DX is also transferred to the driver unit DUj+1 of the subsequent stage.

The latch circuit 520 latches the designation data Dx supplied from the shift register 510 at the timing when the latch signal LAT is turned to be active. With regard to the latch signal LAT, a horizontal scanning period is one cycle, and the latch signal LAT is turned to be active for every horizontal scanning period. Here, if the designation data Dx with respect to the drive signals X[1], X[2], . . . , and X[n] to be supplied to n data lines are represented as Dx[1], Dx[2], . . . , and Dx[n], the latch signal LAT is turned to be active at the timing when the designation data Dx[1], Dx[2], . . . , and Dx[n] are output from the shift register 510 of the respective driver units DU1, DU2, . . . , and DUn.

In addition, the lamp signal Vr supplied from the lamp signal generating circuit 341 is supplied to an amplitude control circuit 540 through the voltage follower 530. The amplitude control circuit 540 controls the amplitude of the lamp signal Vr in accordance with the designation data Dx[j]. In this example, the n driver units DU1, DU2, . . . , and DUn are allowed to function as one lamp signal generating circuit 341 in addition to their original functions. Therefore, it is possible to simplify the configuration. Furthermore, the lamp signal Vr supplied to the respective driver units DU1, DU2, . . . , and DUn are identical, which results in no variation in the signals. Accordingly, it is possible to enhance the accuracy of the display gradation.

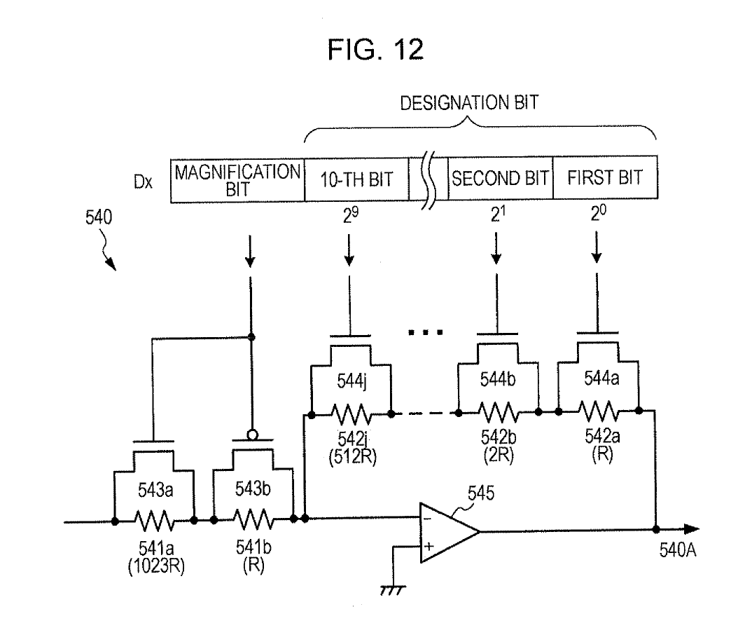

FIG. 12 shows the detailed configuration of the amplitude control circuit 540 and the designation data. The designation data Dx is configured to include one magnification bit and a plurality of designation bits (in this example, 10 designation bits). The magnification bit designates a gain of one or more in the case of “1”, and designates a gain of less than one in the case of “0”. In other words, the magnification bit designates whether to increase or decrease the time rate of change of the potential of the drive signal compared to the time rate of change of the potential of the lamp signal. On the other hand, the plurality of designation bits designates the ratio between the time rates of change of the potentials of the drive signal and the lamp signal. The designated gradation D and the designation data Dx are stored in the lookup table 342 while being associated with each other. In addition, the designation data Dx can be obtained by a predetermined calculation with a designated gradation D as a variable, and this embodiment is not intended to prohibit this. However, it is possible to significantly shorten the time for processing by employing the lookup table 342, which implements a real-time processing.

The amplitude control circuit 540 includes an operational amplifier 545, input resistances 541a and 541b, feedback resistances 542a, 542b, . . . , and 542j, select transistors 543a and 543b for the input resistances, and select transistors 544a, 544b, . . . , and 544j for the feedback transistors.

The gates of the select transistors 543a and 543b are supplied with the magnification bit. The select transistor 543a is a P-channel transistor while the select transistor 543b is an N-channel transistor. Accordingly, the select transistors 543a and 543b are exclusively turned to the ON state. When the magnification bit is “1”, the select transistor 543a is turned on, and the input resistance 541a is shortened. Accordingly, only the input resistance 541b functions as an input resistance, and the resistance value thereof becomes “R”.

On the other hand, the feedback resistances 542a to 542j are selected by the select transistors 544a to 544j. For example, when the select transistors 544b, 544c, . . . , and 544j are turned to the on state, and the select transistor 544a is in the off state, the value of the feedback resistance becomes “R”, which is the minimum value of the feedback resistance. In addition, when all the select transistors 544a to 544j are in the off state, the value of the feedback resistance becomes “1023R”, which is the maximum value of the feedback resistance. As described above, the values available for the feedback resistances are “R”, “2R”, . . . , and “1023R”.

Here, when the magnification bit is “1”, the input resistance becomes “R”. Therefore, the gains of the amplitude control circuit 540 become “1”, “2”, and “1023”. When the magnification bit is “0”, the input resistance becomes “1023R”. Therefore the gains of the amplitude control circuit 540 become “1/1023”, “2/1023”, . . . , “1”. Accordingly, it is possible to designate the gain of “1” or more and the gain of less than “1” by combining the magnification bit and the plurality of designation bits.

The gains are designated so as to amplify or attenuate the lamp signal in this manner for the following reasons. The first reason is to improve the SN ratio. It is possible to consider a method in which a lamp signal is generated with an amplitude corresponding to the minimum gain and this is amplified by a gain corresponding to a gradation to be displayed, for example. This results in a lamp signal with a small amplitude, thereby degrading the SN ratio of the lamp signal.

The second reason is to reduce the power consumption. It is possible to consider a method in which the lamp signal is generated with an amplitude corresponding to the maximum gain and this is attenuated with the attenuation rate corresponding to the gradation to be displayed, for example. This results in the lamp signal with a large amplitude, thereby increasing the power consumption.

Although there is a trade-off relationship between the SN ratio and the power consumption, it is possible to balance the improvement of the SN ratio with the decrease in the power consumption by setting the time rate of change of the lamp signal Vr to the intermediate gradation of the gradation to be displayed according to the embodiments of the invention.

Referring again to FIG. 11, an output signal 540A from the amplitude control circuit 540 is supplied to the offset circuit 550. The offset circuit 550 adds the first offset voltage Vofs1 and the second offset voltage Vofs2 to the output signal 540A from the amplitude control circuit 540, and generates an output signal 550A. The voltage follower 560 functions as a buffer, and outputs the output signal 550A from the offset circuit 550 as the drive signal X[j].

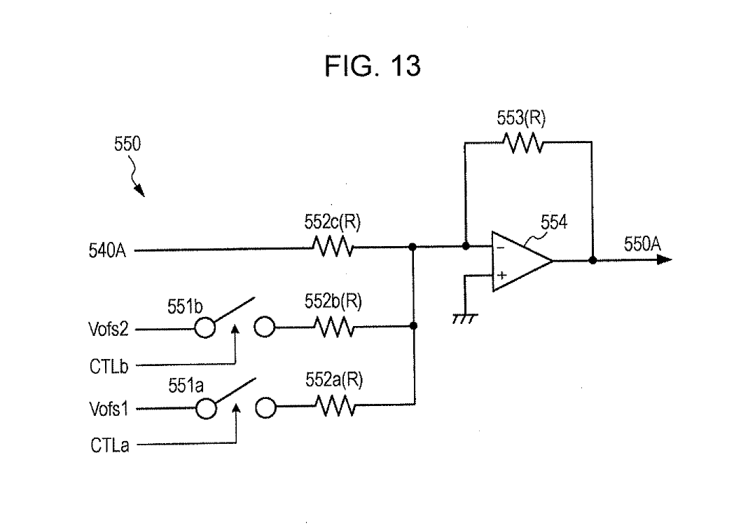

FIG. 13 shows a detailed configuration of the offset circuit 550. As shown in this drawing, the output signal 540A is supplied to a negative input terminal of an operational amplifier 554 through an input resistance 552c. The first offset voltage Vofs1 is supplied to the negative input terminal of the operational amplifier 554 through a switch 551a and an input resistance 552a. The second offset voltage Vofs2 is supplied to the negative input terminal of the operational amplifier 554 through a switch 551b and an input resistance 552b. In addition, the positive input terminal of the operational amplifier 554 is grounded, and the output terminal and the negative input terminal are connected with each other through a feedback resistance 553. Here, all the resistance values of the input resistances 552a, 552b, and 552c and the feedback resistance 553 are “R”. In addition, the switch 551a turns on when a control signal CTLa is in a high level while it turns off when the control signal CTLa is in a low level. In the same manner, the switch 551b turns on when a control signal CTLb is in a high level while it turns off when the control signal CTLb is in a low level. In this regard, the control signals CTLa and CTLb are commonly used for all the driver units DU1 to DUn, and supplied from the control circuit.

The following are embodiments for the operation of the offset circuit 550.

### 1. FIRST EMBODIMENT

In the first embodiment, the control signals CTLa and CTLb are always in the OFF state and the drive signal X[j] is not supplied with the offset voltage. The drive signal X[j] is shown in FIG. 6. In this case, the offset circuit 550 may be omitted to directly supply the output signal 540A of the amplitude control circuit 540 to the voltage follower 560.

As shown in the example of FIG. 6, in the case of changing the potential VX of the drive signal X[j] with a high time rate of change RX under the condition that the potential VX of the drive signal X[j] is allowed to continuously rise from the start time point is of the unit period H[i] and the selection switch TSL (refer to FIG. 4) is controlled to be the OFF state at the last time point to of the unit period H[i] regardless of the designated gradation D (that is, in the case of securing a sufficient amount of the drive current IDR), the potential VX of the drive signal X[j] is required to be set to a significantly high potential at the last time point te of the unit period H[i]. Accordingly, the signal line drive circuit 34 is required to have a high pressure resistance. Furthermore, in order to maintain the selection switch TSL to be in the ON state until the last time point te of each unit period H[i], it is necessary to set the selection potential VSL of the selection pulse PSL to be higher than a voltage which is higher than the potential VX of the drive signal X[j] at the last time point te of the unit period H[i] by the threshold voltage VTH_SL of the selection switch TSL. Therefore, the scanning line drive circuit 32 also requires a high pressure resistance. Considering the above mentioned facts, an embodiment for reducing the amplitude of the drive signal X[j] (and accordingly reducing the requirement of the pressure resistance for the scanning line drive circuit 32 and the signal line drive circuit 34) is exemplified as follows.

### 2. SECOND EMBODIMENT

Before describing the second embodiment, a correlation between the time rate of change RX of the potential VX of the drive signal X[j] and the time required for the source potential VS of the drive transistor TDR to reach the equilibrium state (that is, the time required for the time rate of change RS of the potential VS to converge to the time rate of change RX of the drive signal X[j]) will be considered.

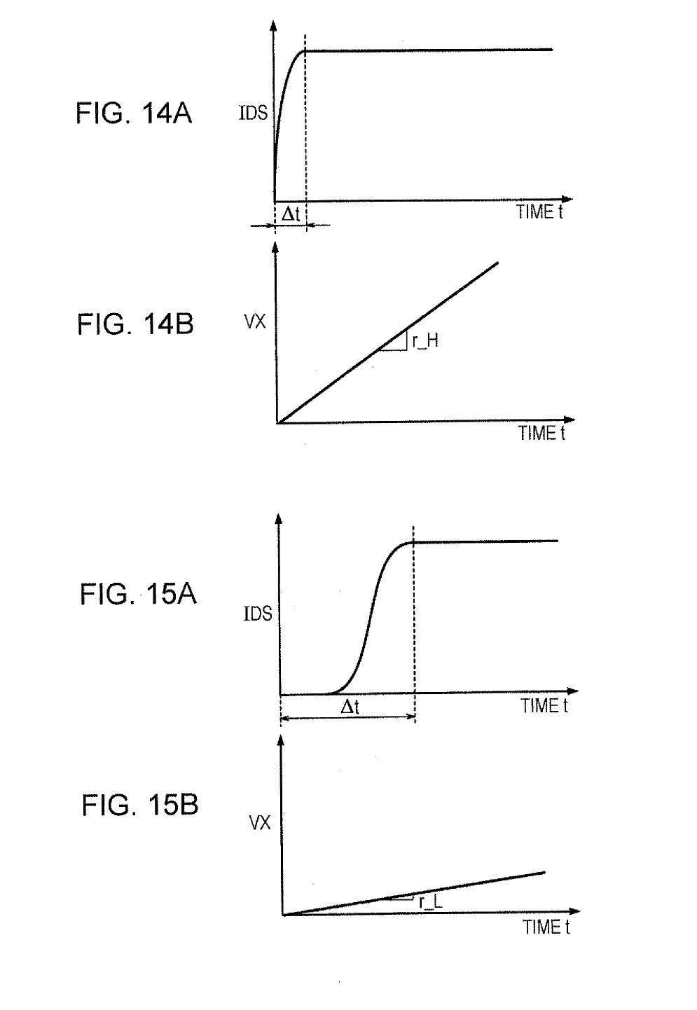

FIGS. 14A, 14B, 15A, and 15B are graphs illustrating correlations between the time rate of change RX of the potential VX of the drive signal X and the drain-to-source current IDS of the drive transistor TDR. FIG. 14A shows a variation of the current IDS with respect to the time passage in the case of changing the potential VX with a time rate of change RX(r_H) corresponding to a high intermediate gradation DH in the same manner as in FIG. 14B. On the other hand, FIG. 15A shows a variation of the current IDS with respect to the time passage in the case of changing the potential VX with a time rate of change RX(r_L) corresponding to a low intermediate gradation DL in the same manner as in FIG. 15B. In FIGS. 14A to 15B, the gate-to-source voltage VGS of the drive transistor TDR is set to be close to the threshold voltage VTH at the time point when the potential VX starts to change (the leftmost part of each graph). Therefore, the current IDS at the time point when the potential VX starts to change is zero.

As can be understood from the equation (3), the amount of the current IDS is stabilized to a predetermined value corresponding to the time rate of change RX of the drive signal X[j] when the source potential VS of the drive transistor TDR reaches the equilibrium state after the start of the variation of the potential VX of the drive signal X[j]. It can be understood from the comparison between FIGS. 14A and 15A that the time Δt required for the source potential VS to reach the equilibrium state tends to be longer when the time rate of change RX is lower.

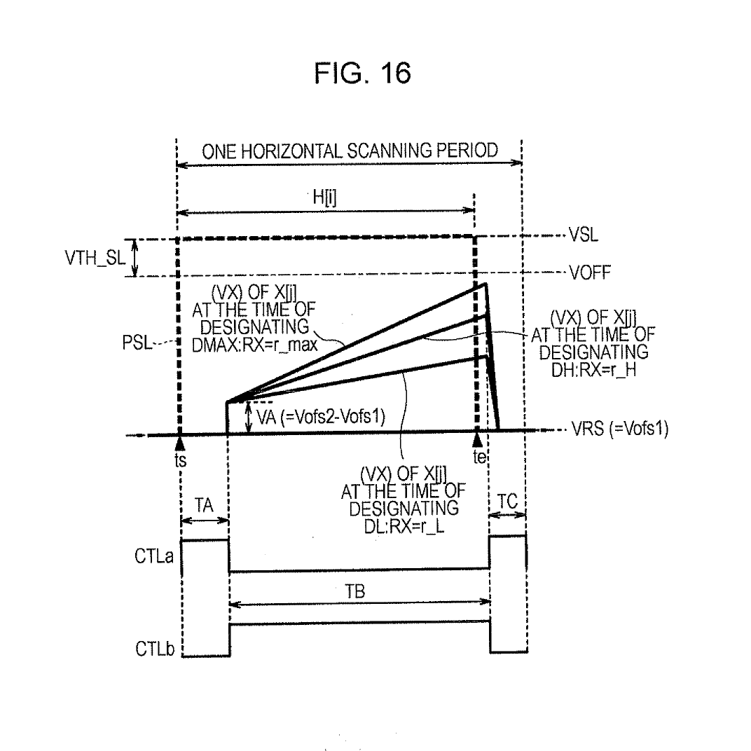

FIG. 16 is a waveform diagram of the drive signal X[j] within the unit period H[i] according to the second embodiment. The first embodiment was an example of the case where the potential VX of the drive signal X[j] was continuously changed from the reference potential VRS. According to the second embodiment, the time rate of change RX corresponding to the designated gradation D is changed with the passage of time after changing the potential VX of the drive signal X[j] from the reference potential VRS to an adjusted potential VA as shown in FIG. 16. The time point when the potential VX of the drive signal X[j] varies from the reference potential VRS to the adjusted potential VA corresponds to the time point when an adjusted time TA elapses from the start time point is of the unit period H[i]. In this example, the adjusted time TA and the adjusted potential VA are fixed. In addition, the reference potential VRS is provided as the first offset voltage Vofs1.

In the offset circuit shown in FIG. 13, when control signal CTLa enters a high level state during the periods TA and TC in one horizontal scanning period, the first offset voltage Vofs1 is added to the output signal 550A. As a result, the reference potential VRS is provided as a potential VX of the drive signal X[j]. Meanwhile, when the control signal CTLa enters a high level state during the period TB, the second offset voltage Vofs2 is added to the output signal 550A. As a result, the potential VX of the drive signal X[j] changes from the reference potential VRS to the adjusted potential VA.

When the offset in a time axis direction (the adjusted time TA) and the offset in a potential direction (the adjusted potential VA) are provided as described above, the current IDS of the equation (2) starts to flow through the drive transistor TDR at the time point when the potential VX of the drive signal X[j] is allowed to rise from the reference potential VRS to the adjusted potential VA. Therefore, it is possible to shorten the time required for the drive transistor TDR to reach the equilibrium state within the unit period H[i] as compared with the first embodiment in which the potential VX is continuously changed from the reference potential VRS. More detailed description will be made hereinafter.

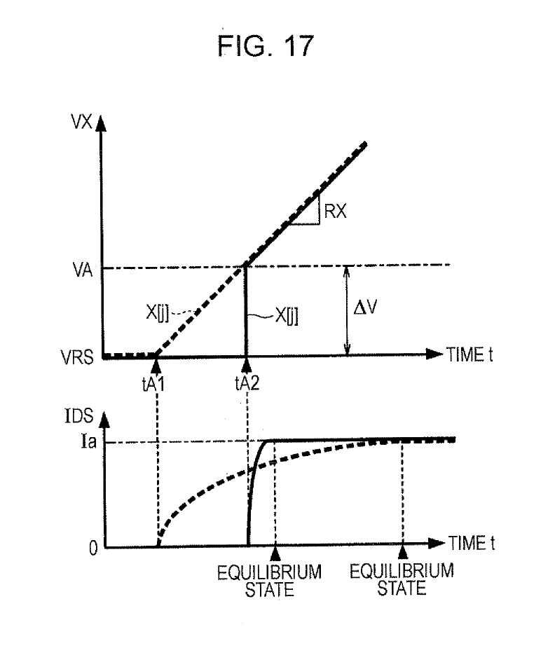

FIG. 17 shows the drive signal X[j] and the current IDS (where both are represented by dashed lines) in the case of starting to change the potential VX continuously with the time rate of change RX from the reference potential VRS at the time point tA1 within the unit period H[i]. FIG. 17 also shows the drive signal X[j] and the current IDS (where both are represented by solid lines) according to this embodiment in which the potential VX is changed at the time rate of change RX after the potential VX is changed from the reference potential VRS to the adjusted potential VA at the time point tA2.

As shown by the dashed line in FIG. 17, the current IDS gradually increases from the time point tA1 and reaches the target value Ia corresponding to the designated gradation D when the potential VX is continuously changed from the reference potential VRS. Meanwhile, when the potential VX is changed from the reference potential VRS to the adjusted potential VA at the time point tA2, the current IDS close to the target value Ia flows immediately after the time point tA2, and therefore the drive transistor TDR can rapidly reach the equilibrium state. As described above, since the time for the drive transistor TDR to reach the equilibrium state is reduced, there is an advantage of shortening the unit period H[i] according to this embodiment (furthermore, it is possible to implement the display images with high definition by increasing the number of the scanning lines 12).

In order for the drive transistor TDR to reach the equilibrium state, it is necessary to continuously change the potential VX of the drive signal X[j] at the time rate of change RX. According to this embodiment, the potential VX is changed to the adjusted potential VA, and therefore the drive transistor TDR can rapidly reach the equilibrium state. Accordingly, it is possible to shorten the time required for changing the potential VX of the drive signal X[j] at the time rate of change RX. That is, the drive transistor TDR can reach the equilibrium state without continuously changing the potential VX until the potential VX excessively rises. Accordingly, there is also an advantage of reducing the amplitude of the drive signal X[j] (and furthermore it is possible to reduce the pressure resistance requirement for the scanning line drive circuit 32 and the signal line drive circuit 34).

In addition, the organic EL eminent is one of the examples of the light emitting elements. This invention can be applied to other light emitting devices with light emitting elements such as inorganic EL elements, LEDs (Light Emitting Diodes), or the like arranged therein in the same manner as in the respective embodiments described above. The light emitting elements in this invention are current-driven type driven elements which are driven by the supply of the current (the gradation (luminance) is typically controlled).

### C: Applications

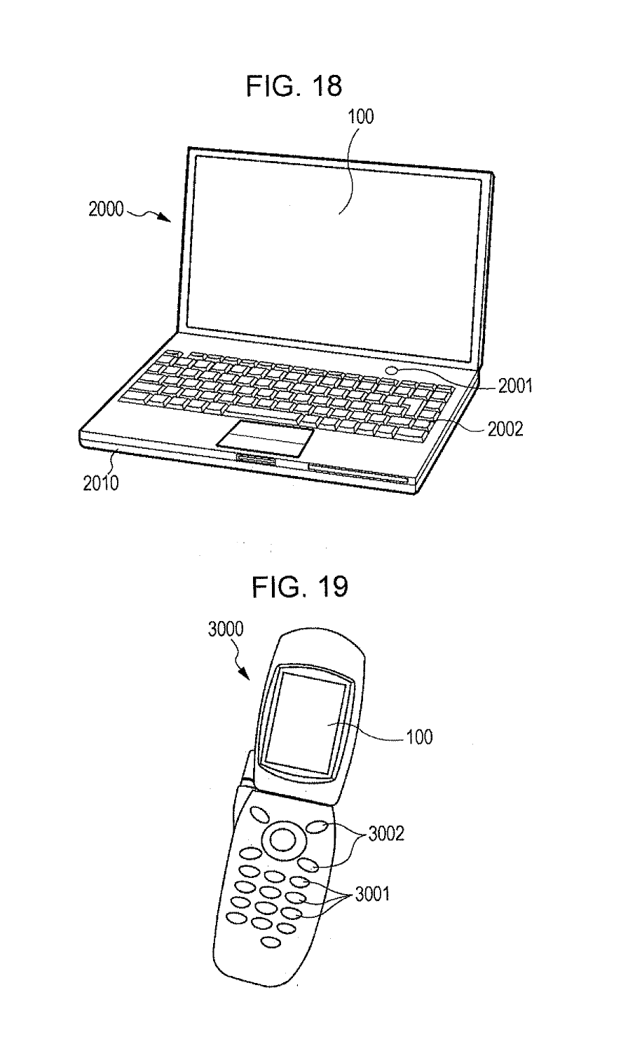

Next, the description will be made of the electronic apparatuses each of which uses the light emitting device 100 according to the above-mentioned embodiments. FIGS. 18 to 20 show the configurations of the electronic apparatuses employing the light emitting devices 100 as display devices.

FIG. 18 is a perspective view illustrating a configuration of a mobile type personal computer employing the light emitting device 100. The personal computer 2000 includes the light emitting device 100 for displaying various images and a main body part 2010 with a power switch 2001 and a keyboard 2002 provided thereon. Since the organic EL elements are used as light emitting elements E in the light emitting device 100, it is possible to implement a broad viewing angle and easily viewed displays.

FIG. 19 is a perspective view illustrating a configuration of a mobile phone to which the light emitting device 100 is applied. The mobile phone 3000 includes a plurality of operating buttons 3001, scroll buttons 3002, and a light emitting device 100 for displaying various images. The screen displayed on the light emitting device 100 is scrolled by operating the scroll buttons 3002.

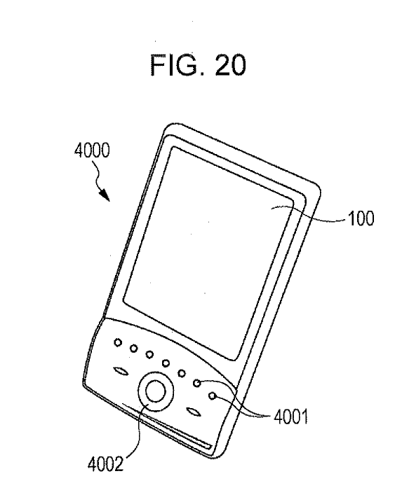

FIG. 20 is a perspective view illustrating a configuration of a personal digital assistant (PDA) to which the light emitting device 100 is applied. The PDA 4000 includes a plurality of operating buttons 4001, a power switch 4002, and the light emitting device 100 for displaying various images. If the power switch 4002 is operated, the light emitting device 100 displays various pieces of information such as an address list, a schedule book, and the like.

As the electronic apparatuses to which the light emitting device 100 according to the invention is applied, it is possible to exemplify a digital still camera, a television, a video camera, a car navigation system, pager, an electronic organizer, an electronic paper, a calculator, a word processor, a work station, a video phone, a POS terminal, a printer, a scanner, a copy machine, a video player, an apparatus with a touch panel, and the like in addition to the apparatuses shown in FIGS. 18 to 20. Furthermore, the purpose of the light emitting device 100 according to the present invention is not limited to the display of images. The light emitting device 100 according to the present invention can be used as an exposure device which is mounted on a xerographic image forming device and forms latent images on a photoconductor drum by exposure.

The entire disclosure of Japanese Patent Application No. 2009-132844, filed Jun. 2, 2009 is expressly incorporated by reference herein.

1. A light emitting device comprising:
pixel circuits, each of which includes a light emitting element and a drive transistor connected in series with each other and a holding capacitor disposed between a path connecting the light emitting element and the drive transistor and a gate of the drive transistor; and
a drive circuit which supplies a drive signal to the gate of the drive transistor and changes a potential of the drive signal with the passage of time such that a time rate of change of the potential of the drive signal at the time point of stopping the supply of the drive signal becomes a time rate of change corresponding to a designated gradation of the pixel circuit,
wherein the drive circuit includes:
a lamp signal generating unit which generates a lamp signal; and
an amplitude control unit which is supplied with the lamp signal, adjusts the amplitude of the lamp signal in accordance with a gradation to be displayed, and outputs the adjusted signal, and
wherein the drive circuit generates the drive signal based on the output signal from the amplitude control unit.

2. The light emitting device according to claim 1,
wherein the drive circuit includes:
an offset unit which adds an offset potential to the output signal from the amplitude control unit and generates the drive signal.

3. The light emitting device according to claim 1,
wherein the lamp signal generating unit includes:
a capacitance element connected to a node;
a constant current source with an output terminal connected to the node;
a discharging unit which is connected to the node and discharges the electric charges charged in the capacitance element at a predetermined timing; and
a buffer which has an input terminal connected to the node and outputs the lamp signal.

4. The light emitting device according to claim 1,
wherein the drive circuit is supplied with designation data for designating a time rate of change of the potential of the drive signal,
wherein the designation data includes:
a magnification bit for designating whether to increase or decrease the time rate of change of the potential of the drive signal as compared with a time rate of change of the potential of the lamp signal; and
a plurality of designation bits which designates a ratio between the time rates of change of the potentials of the drive signal and the lamp signal, and
wherein the amplitude control unit controls gains in accordance with the plurality of designation bits such that the gain becomes one or more when the magnification bit designates the increase in the time rate of change of the potential of the lamp signal and the gain becomes less than one when the magnification bit designates the decrease in the time rate of change of the potential of the lamp signal.

5. The light emitting device according to claim 4,
wherein the amplitude control unit includes an amplification circuit having:
input resistances;
feedback resistances; and
an operational amplifier, and
wherein the amplitude control unit selects magnitudes of the input resistances in accordance with the magnification bit and magnitudes of the feedback resistances in accordance with the plurality of designation bits.

6. The light emitting device according to claim 1,
wherein the drive circuit includes a storage unit which associates gradation data for instructing a gradation to be displayed with the designation data and stores both the data, and
wherein when the gradation data is supplied, the drive circuit converts the gradation data into the designation data with reference to the contents stored in the storage unit.

7. The light emitting device according to claim 1, including:
a plurality of scanning lines;
a plurality of data lines; and
the plurality of pixel circuits, each of which is disposed at each of the intersections between the plurality of scanning lines and the plurality of data lines,
wherein the drive circuit includes:
the single lamp signal generating unit; and
the plurality of amplitude control unit to which the lamp signal is supplied, and
wherein the drive circuit supplies the drive signal output from the plurality of amplitude control units to the plurality of data lines.

8. An electronic apparatus comprising the light emitting device according to claim 1.

9. An electronic apparatus comprising the light emitting device according to claim 2.

10. An electronic apparatus comprising the light emitting device according to claim 3.

11. An electronic apparatus comprising the light emitting device according to claim 4.

12. An electronic apparatus comprising the light emitting device according to claim 5.

13. An electronic apparatus comprising the light emitting device according to claim 6.

14. An electronic apparatus comprising the light emitting device according to claim 7.
